(19) United States
(12) Patent Application Publication
(10) Pub. No.: US 2019/0297851 A1
(43) Pub. Date: Oct. 3, 2019

(54) COMBINATION PET HARNESS AND LIFE VEST

(71) Applicant: Radio Systems Corporation, Knoxville, TN (US)

(72) Inventors: Krista Nixon, Knoxville, TN (US); Nicole Backus, Knoxville, TN (US)

(21) Appl. No.: 16/366,649

(22) Filed: Mar. 27, 2019

Related U.S. Application Data
(60) Provisional application No. 62/648,501, filed on Mar. 27, 2018.

(51) Int. Cl. A01K 27/00; B63C 9/125

(52) U.S. Cl. CPC A01K 27/002; B63C 2009/084; B63C 9/1255

(57) ABSTRACT

A pet harness and life vest is disclosed having a body portion which includes an outer shell which forms an envelope in which resides an inflatable bladder. The inflatable bladder includes a back portion and two oppositely disposed side chambers or portions. The inflatable bladder also includes a manually actuated air pump having a bulb with a check valve which in turn is coupled to a release valve and an elongated air tube sealed to the inflatable bladder for the introduction of air into the bladder. The pet harness also includes a flexible chest strap and a flexible belly strap. Lastly, the pet harness has a hand grip which includes a coupler in the form of a D-ring to enable a leash to be coupled to the pet harness.

### CROSS REFERENCE TO RELATED APPLICATIONS

This application claims the benefit of U.S. Application No. 62/648,501, filed Mar. 27, 2018.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Field of the Invention

The present inventive concept relates to the field of pet harnesses. More particularly, the invention relates to a pet harness which may also be utilized as a pet life vest.

### Technology in the Field of the Invention

Pet owners enjoy walking their pets, and especially their dogs, on a daily basis to provide the animal with exercise and the ability to explore the world. Many dog owners use a collar which fits about the neck of the dog. A problem with such collars is that the dog may slip out of the collar by pulling in a reverse direction. Another problem is the pressure of the collar on the dog places a great deal of strain upon the neck and the bones of the neck, which may cause discomfort or injury.

Conventional pet harnesses are used as an alternative to a pet collar for ease in controlling a pet, such as a dog, during a walk or other exercise routine. These harnesses typically include several straps that are mount about the body of the dog rather than merely around the neck. This body type mounting provides for better control of the dog while minimizing the danger to the neck region of the dog. These harnesses also eliminate the problem of a dog being able to escape the collar by “backing out” of the collar.

Pet life vests have also existed for many years. These pet life vests are typically made of a foam material which are sized and shaped to fit about the torso of the animal. A problem with these pet life vests is that they do not breath and therefore capture the body heat produced by the animal, thus making them uncomfortable for the animal when out of the water for an extended period of time. They are also not conducive to walking a pet.

The combination pet harnesses and life vests of the present invention are designed to provide complete control of the animal when walking while also providing the ability to assist the animal should it desire to swim.

A need therefore exists for an improved pet harness which enables the pet to be controlled during a walk yet enables it to also swim should the need arise.

### BRIEF SUMMARY OF THE INVENTION

A combination pet harness and life vest comprises a body portion having an outer shell and an internal inflatable bladder. The bladder is fitted with a manual air pump for inflation and a release valve for deflation. The pet harness and life vest also includes a chest strap and a belly strap for maintaining the body portion in a proper position upon the animal.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an illustrative combination pet harness and life vest embodying principles of the invention in a preferred form, shown being worn by a dog.

FIG. 2 is a perspective, exploded view of the combination pet harness and life vest of FIG. 1.

FIG. 3 is a perspective, exploded view of a combination pet harness and life vest in another preferred form of the invention.

FIG. 4 is a perspective view of an illustrative combination pet harness and life vest embodying principles of the invention in another preferred form, shown being worn by a dog.

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### DESCRIPTION OF SELECTED SPECIFIC EMBODIMENTS

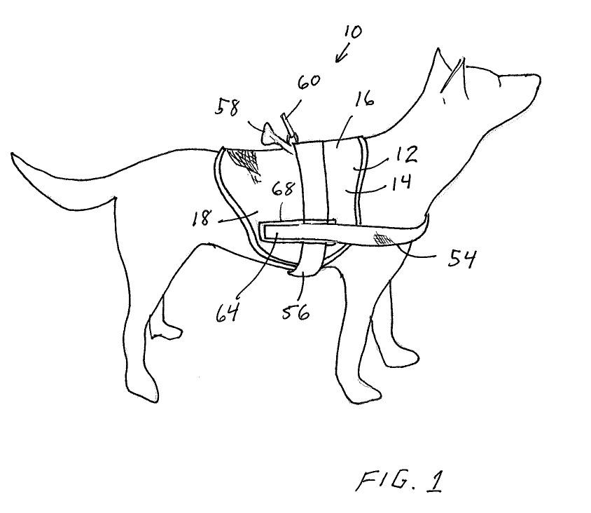

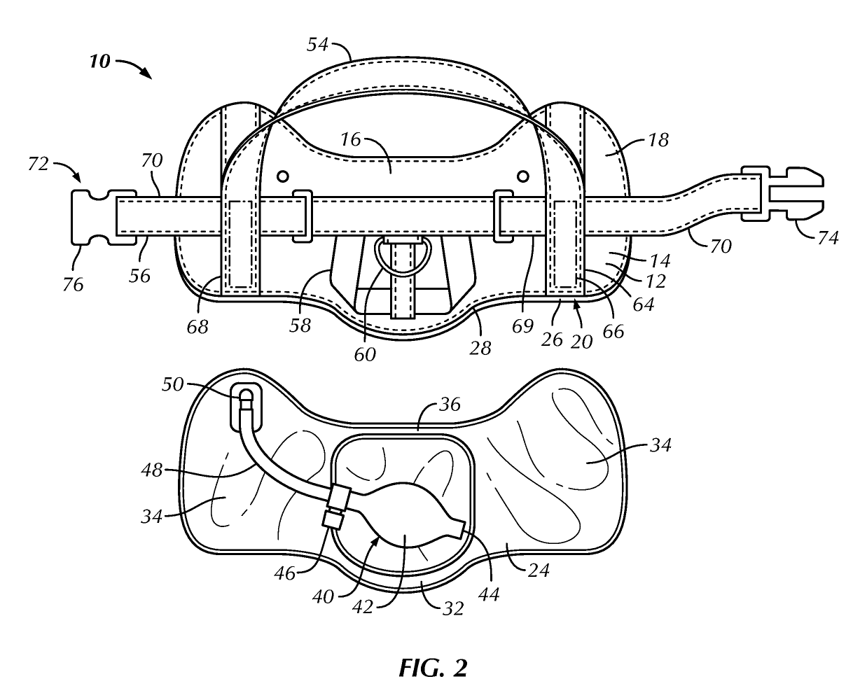

With reference next to FIGS. 1 and 2 of the drawings, there is a shown a combination pet harness and life vest 10 embodying principles of the invention in a preferred form. For ease of explanation, the combination pet harness and life vest 10 will be referred to herein as a pet harness.

The pet harness 10 includes a saddle or body portion 12 which includes an outer shell 14 having a back portion 16 configured to fit over the back of the dog's torso and two oppositely disposed side portions 18 configured to fit over opposite sides of the dog's torso. The outer shell 14 is made a flexible material to conform to the general shape of the dog. The outer shell 14 forms an envelope or housing defining an internal cavity 20 in which resides a flexible, inflatable bladder 24. The outer shell 14 has an opening 26 that includes a closure 28, which may be in the form of a zipper, hook and loop type fasteners, or other conventionally know fasteners. The bladder 24 may be removed from or inserted into the cavity 20 of the outer shell through the opening 26 and secured therein through the closing of the opening closure 28.

The inflatable bladder 24 includes a back portion 32 and two oppositely disposed side chambers or portions 34 which are sized and shaped generally to conform with the corresponding portions of the outer shell 14. Preferably, the inflatable bladder side portions 34 are inflatable while at least a portion of the back portion 32 is generally not inflatable. This configuration with the inflated regions positioned low along the body portion 12 is believed to provide better floatation by elevating the dog above the waterline. The inflatable bladder two side portions 34 are in fluid communication with each other through channels 36, thereby allowing for a portion of the air introduced into one side portion 34 to travel into and inflate the oppositely disposed side portion 34. The bladder 24 may be made of a flexible plastic or polymer material.

The inflatable bladder 24 also includes a manually actuated air pump 40. The air pump 40 is in the form of a resilient, compressible air pressurizing bulb 42 having a check valve 44 to permit the introduction of air into the bulb 42 during bulb expansion while preventing the escape of air during bulb contraction. The air pump 40 also includes a release valve 46 coupled to the bulb 42 and an elongated air tube 48 extending from the release valve 46 to an air intake fitment 50 sealed to one of the inflatable bladder side portions 34 for the introduction of air into the bladder 24.

The pet harness 10 also includes a flexible chest strap 54 which is configured to be positioned over the prosternum of the dog and a flexible belly strap 56 which is configured to be positioned about the chest and abdomen of the dog, as best shown in FIG. 1. Lastly, the pet harness 10 has a hand grip or loop 58 which includes a coupler in the form of a D-ring 60 to enable a leash to be coupled to the pet harness 10.

The chest strap 54 is made of a flexible material, such as a woven strap or the like. One or both ends 64 of the chest strap 54 may include hook and loop type fasteners 66 which enable the straps length to be adjusted for a proper fit about the forechest of the dog. The hook and loop type fasteners 66 are removably coupled to corresponding hook and loop fasteners on strap mounts 68 which are fixedly mounted to the body portion 12.

The belly strap 56 is also made of a flexible material, such as a woven strap, and a portion, or portions, is fixed to the body portion 12 at a mounting area 69 through stitching, strap loops, or other mounting means to maintain the belly strap's position relative to the body portion 12. The belly strap 56 has loose opposite ends 70 which are fitted with a compressible type snap or buckle 72 to couple the ends 70 together. A first portion 74 of the buckle 72 may be in the form of a male portion, while the second portion 76 of the buckle may be in the form of a corresponding female portion. The length of the belly strap 56 may be adjusted through adjusting the length of the belly strap 56 between the mounting area 69 and one of more of the buckles, or by adjusting the length of a middle portion of the belly strap in conventional fashion. The belly strap 56 should fit snuggly about the abdomen of the dog to prevent the pet harness 10 from separating from the dog or interfering with the free movement of the dog's legs.

In use, the pet harness 10 is positioned upon a dog with the body portion 12 draped across the dog's back and chest sides. The chest strap 54 is positioned across the prosternum and the belly strap 56 is positioned about the abdomen. The length of the chest strap 54 is adjusted through the positioning or mounting of the strap ends 64 by fasteners 66 so as to be snug upon the dog. The length of the belly strap 56 is adjusted through adjustment of the buckle portions 74 and 76, or adjustment of a doubled, middle portion of the belly strap as conventionally know.

It should be understood that the hand grip 58 provides a handle so that a dog owner may lift the dog from the water by grasping and lifting upon the hand grip 58.

Once the pet harness 10 is properly fitted, a leash may be coupled to the pet harness through attachment to the D-ring 60. The dog may then be walked and controlled through the combination of the leash and pet harness.

Should the pet owner and dog encounter an opportunity to swim or for safety in case of unwanted or unexpected encounter with water, the owner may manually actuate the air pump 40 by repeatedly squeezing the bulb 42. The squeezing action of the bulb 42 causes air to be passed through air tube 48 and fitment 50 and into the air bladder 24. The air initially enters one side portion 34 wherein a portion of the air travels through air channels 36 into the other side portion 34 until the air pressure in both side portions 34 is equal. With the air bladder 24 fully inflated, the pet harness 10 aids in providing buoyancy to the dog.

With the air bladder 24 fully inflated, the pet harness 10 may provide a therapeutic effect in that the compression of the bladder and harness around the animal may relieve or reduce anxiety of the animal.

Once the swimming opportunity or danger of unwanted water encounter has passed, the air within the air bladder 24 may be released through manual actuation of the release valve 46. The release of the air from the air bladder 24 will return the pet harness to its initial, slimmed down or deflated configuration to enable controlled walking of the dog.

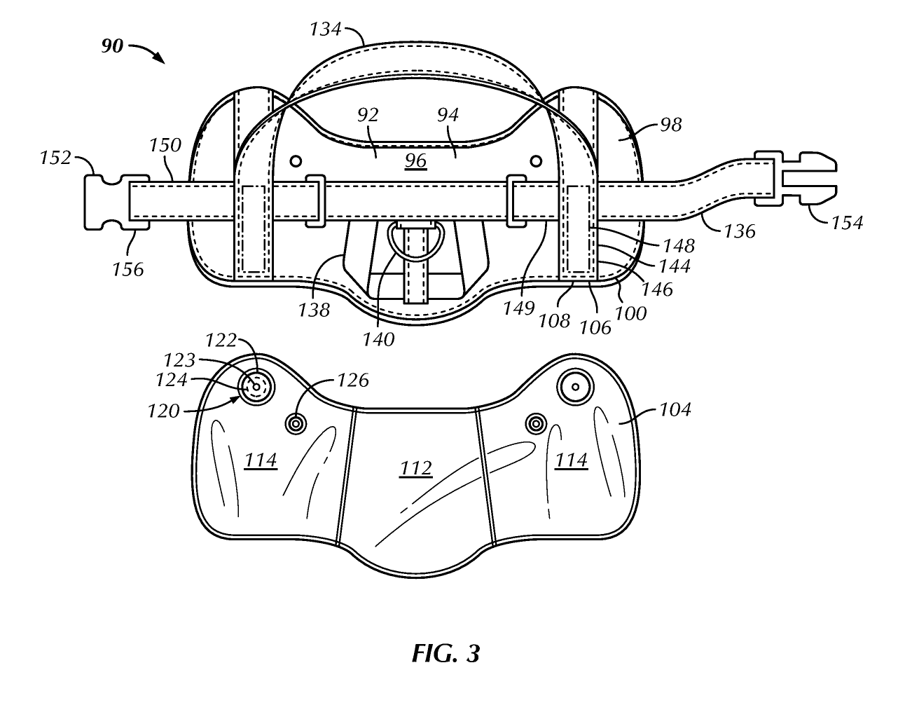

With reference next to FIG. 3, there is shown a combination pet harness and life vest 90 in another preferred form of the present invention. For ease of explanation, the combination pet harness and life vest 90 will be referred to herein as a pet harness.

The pet harness 90 includes a saddle or body portion 92 which includes an outer shell 94 having a back portion 96 configured to fit over the back of the dog's torso and two oppositely disposed side portions 98 configured to fit over opposite sides of the dog's torso. The outer shell 94 is made a flexible material to conform to the general shape of the dog. The outer shell 94 forms an envelope or housing defining an internal cavity 100 in which resides a flexible, inflatable bladder 104. The outer shell 94 has an opening 106 that includes a closure 108, which may be in the form of a zipper, hook and loop type fasteners, or other conventionally know fasteners. The bladder 104 may be removed from or inserted into the cavity 100 of the outer shell through the opening 106 and secured therein through the closing of the opening closure 108.

The inflatable bladder 104 includes a back portion 112 and two oppositely disposed side chambers or portions 114 which are sized and shaped generally to conform with the corresponding portions of the outer shell 94. Preferably, the inflatable bladder side portions 114 are inflatable while at least a portion of the back portion 112 is generally not inflatable. This configuration with the inflated regions positioned low along the body portion 92 is believed to provide better floatation by elevating the dog above the waterline. The bladder 104 may be made of a flexible plastic or polymer material.

Each side portion 114 of the inflatable bladder 104 also includes a manually actuated air pump 120. The air pump 120 is in the form of a resilient, compressible air pressurizing bulb 122 having an air inlet hole 123 and an internal check valve 124 to permit the introduction of air from the bulb 122 into the bladder side portion 114 during bulb compression while preventing the escape of air from the bladder side portion 114 back into the bulb 122 during bulb expansion. Each air bladder side portion 114 also includes a includes a release valve 126 which allows air to escape the bladder side portion 114.

The pet harness 90 also includes a flexible chest strap 134 which is configured to be positioned over the prosternum of the dog and a flexible belly strap 136 which is configured to be positioned about the chest and abdomen of the dog, as best shown in FIG. 1. Lastly, the pet harness 90 has a hand grip or loop 138 which includes a coupler in the form of a D-ring 140 to enable a leash to be coupled to the pet harness 90.

The chest strap 134 is made of a flexible material, such as a woven strap or the like. One or both ends 144 of the chest strap 134 may include hook and loop type fasteners 146 which enable the straps length to be adjusted for a proper fit about the forechest of the dog. The hook and loop type fasteners 146 are removably coupled to corresponding hook and loop fasteners on strap mounts 148 which are fixedly mounted to the body portion 92.

The belly strap 136 is also made of a flexible material, such as a woven strap, and a portion, or portions, is fixed to the body portion 92 at a mounting area 149 through stitching, strap loops, or other mounting means to maintain the belly strap's position relative to the body portion 92. The belly strap 136 has loose opposite ends 150 which are fitted with a compressible type snap or buckle 152 to couple the ends 150 together. A first portion 154 of the buckle 152 may be in the form of a male portion, while the second portion 156 of the buckle may be in the form of a corresponding female portion. The length of the belly strap 136 may be adjusted through adjusting the length of the belly strap 136 between the mounting area 149 and one of more of the buckles, or by adjusting the length of a middle portion of the belly strap in conventional fashion. The belly strap 136 should fit snuggly about the abdomen of the dog to prevent the pet harness 90 from separating from the dog or interfering with the free movement of the dog's legs.

In use, the pet harness 90 is positioned upon a dog with the body portion 92 draped across the dog's back and chest sides. The chest strap 134 is positioned across the prosternum and the belly strap 136 is positioned about the abdomen. The length of the chest strap 134 is adjusted through the positioning or mounting of the strap ends 144 by fasteners 146 so as to be snug upon the dog. The length of the belly strap 136 is adjusted through adjustment of the buckle portions 154 and 156, or adjustment of a doubled, middle portion of the belly strap as conventionally know.

It should be understood that the hand grip 138 provides a handle so that a dog owner may lift the dog from the water by grasping and lifting upon the hand grip 138.

Once the pet harness 90 is properly fitted, a leash may be coupled to the pet harness through attachment to the D-ring 140. The dog may then be walked and controlled through the combination of the leash and pet harness.

Should the pet owner and dog encounter an opportunity to swim or for safety in case of unwanted or unexpected encounter with water, the owner may manually actuate the air pumps 120 by repeatedly pressing on or squeezing the bulbs 122. The squeezing action of the bulbs 122 causes air to be passed from the bulbs 122 into the side portions 114 of the bladder 104. The operator's finger is placed over the bulb's air inlet holes 123 during the compression motion to prevent air from escaping the bulbs, while releasing the finger over the air inlet holes 123 during the expansion of the bulbs 104 to allow air to enter and refill the bulbs 104 through the air inlet holes 123. With the air bladder 104 fully inflated, the pet harness 90 aids in providing buoyancy to the dog.

With the air bladder 104 fully inflated, the pet harness 90 may provide a therapeutic effect in that the compression of the bladder and harness around the animal may relieve or reduce anxiety of the animal.

Once the swimming opportunity or danger of unwanted water encounter has passed, the air within the air bladder 104 may be released through manual actuation of the release valves 126. The release of the air from the air bladder 104 will return the pet harness to its initial, slimmed down or deflated configuration to enable controlled walking of the dog.

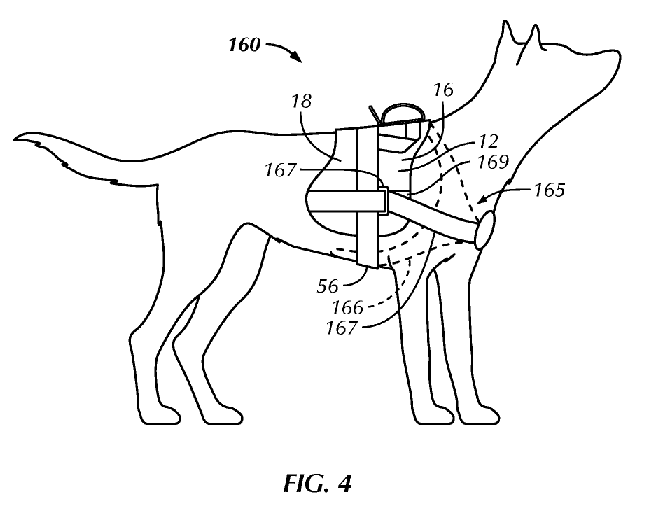

With reference next to FIG. 4, there is shown a combination pet harness and life vest 10 embodying principles of the invention in a preferred form. For ease of explanation, the combination pet harness and life vest 160 will be referred to herein as a pet harness.

Here, the combination pet harness and life vest 160 is generally the same as that shown in FIG. 1. The difference is that the chest strap 54 has been substituted with a neck strap 165. The neck strap 165 may include a generally Y-shaped bottom or chest plate 166 coupled to the body portion 12 through two flexible, adjustable straps 167. The chest plate 166 may be made of a buoyant material. The adjustment of the straps 167 may be provided through adjusting the length through a D-ring 168 coupled to the portion 12 and releasably fastening the straps 167 to themselves through releasable hook and loop type fasteners 169.

A combination pet harness and life vest 10 of an embodiment comprises a flexible outer shell 14 defining an interior cavity 20, a flexible inflatable bladder 24 removably positioned within the interior cavity of the outer shell, an air pump in fluid communication with the inflatable bladder, an air release valve coupled to the inflatable bladder, and at least one mounting strap coupled to the outer shell.

The combination pet harness and life vest 10 also comprises the inflatable bladder 24 including two oppositely disposed inflatable side portions and a central portion positioned between the two oppositely disposed inflatable side portions which is not inflatable.

The combination pet harness and life vest 10 also comprises the at least one mounting strap including a belly strap configured to fit about the torso of a pet.

The combination pet harness and life vest 10 also comprises the at least one mounting strap also including a chest strap configured to fit about the chest of a pet.

The combination pet harness and life vest 10 also comprises the at least one mounting strap also including a neck strap configured to fit about at least a portion of the neck of a pet.

A combination pet harness and life vest 10 of an embodiment comprises a flexible outer shell 14 defining an interior cavity, a flexible inflatable bladder 24 removably positioned within the interior cavity 20 of the outer shell, the inflatable bladder includes two oppositely disposed inflatable side portions and a central portion positioned between the two oppositely disposed inflatable side portions which is not inflatable, and at least one mounting strap coupled to the outer shell.

It will be appreciated that the inventions are susceptible to modification, variation and change without departing from the spirit thereof.

1. A combination pet harness and life vest comprising:
a flexible outer shell defining an interior cavity;
a flexible inflatable bladder removably positioned within the interior cavity of the outer shell;
an air pump in fluid communication with the inflatable bladder;
an air release valve coupled to the inflatable bladder, and
at least one mounting strap coupled to the outer shell.

2. The combination pet harness and life vest of claim 1 wherein the inflatable bladder includes two oppositely disposed inflatable side portions and a central portion positioned between the two oppositely disposed inflatable side portions which is not inflatable.

3. The combination pet harness and life vest of claim 1 wherein the at least one mounting strap includes a belly strap configured to fit about the torso of a pet.

4. The combination pet harness and life vest of claim 3 wherein the at least one mounting strap also includes a chest strap configured to fit about the chest of a pet.

5. The combination pet harness and life vest of claim 3 wherein the at least one mounting strap also includes a neck strap configured to fit about at least a portion of the neck of a pet.

6. The combination pet harness and life vest of claim 2 wherein the two oppositely disposed side portions are in fluid communication with each other through an air channel.

7. A combination pet harness and life vest comprising:
a flexible outer shell defining an interior cavity;
a flexible inflatable bladder removably positioned within the interior cavity of the outer shell, the inflatable bladder includes two oppositely disposed inflatable side portions and a central portion positioned between the two oppositely disposed inflatable side portions which is not inflatable, and
at least one mounting strap coupled to the outer shell.

8. The combination pet harness and life vest of claim 7 wherein the bladder includes an air pump and an air release valve.

9. The combination pet harness and life vest of claim 7 wherein the at least one mounting strap includes a belly strap configured to fit about the torso of a pet.

10. The combination pet harness and life vest of claim 9 wherein the at least one mounting strap also includes a chest strap configured to fit about the chest of a pet.

11. The combination pet harness and life vest of claim 9 wherein the at least one mounting strap also includes a neck strap configured to fit about at least a portion of the neck of a pet.

12. The combination pet harness and life vest of claim 7 wherein the two oppositely disposed side portions are in fluid communication with each other through an air channel.
